(19) United States
(12) Patent Application Publication
(10) Pub. No.: US 2022/0285781 A1
(43) Pub. Date: Sep. 8, 2022

(54) Automatic Active Locking Battery

(71) Applicant: LIBERTY BATTERY TECH, INC., Charlotte, NC (US)

(72) Inventors: Jordan Renfro, Minooka, IL (US); D'Anne Hotchkiss, Charlotte, NC (US)

(73) Assignee: LIBERTY BATTERY TECH, INC., Charlotte, NC (US)

(21) Appl. No.: 17/653,532

(22) Filed: Mar. 4, 2022

Related U.S. Application Data
(60) Provisional application No. 63/157,005, filed on Mar. 5, 2021.

(51) Int. Cl. H01M 50/264; H01M 50/296; H01M 50/258; H01M 10/42; H01M 50/244

(52) U.S. Cl. CPC H01M 50/264; H01M 50/296; H01M 50/258; H01M 10/4257; H01M 50/244; H01M 2220/20

(57) ABSTRACT

Apparatus and associated methods relate to a battery housing configured to selectively lock a battery to the housing when the battery is operated into electrical communication with the housing. In an illustrative example, the housing may have a first indexing member configured to slidingly engage a second indexing member of the battery such that a power terminal of the housing is brought into register with a power terminal of the battery. The housing may, for example, have a control module operably coupled to the housing power terminal and configured to operate the (mechanical) locking module between a lock mode and an unlock mode. The control module may, for example, be configured to operate the locking module into the lock mode when the power terminals are operated into electrical connection with each other. Various embodiments may advantageously automatically lock and/or unlock a battery module in response to predetermined operations.

### CROSS-REFERENCE TO RELATED APPLICATIONS

This application claims the benefit of U.S. Provisional Application Ser. No. 63/157,005, titled “Hot Swappable Vehicle Battery System,” filed by Renfro, et al., on Mar. 5, 2021.

### TECHNICAL FIELD

Various embodiments relate generally to power storage and dispensing.

### BACKGROUND

Energy may be generated, transmitted, stored, and/or consumed in various forms. One common form is in electricity. Electrical energy consumers include communication and/or control circuits (e.g., processors, sensors, transmitters, receivers). Electrical energy consumers include actuators, such as motors, for example.

Electrical motors may be configured, by way of example and not limitation, to be driven by alternating current. Some electrical motors may be configured, for example, to be driven by direct current. Machines may be driven by electrical actuators (e.g., electrical motors).

Some machines driven by electrical actuators include vehicles. For example, an electrical motor may be mechanically coupled to drive one or more wheels of a vehicle. An electrical motor may, for example, compress and/or control a fluid (e.g., hydraulic, pneumatic). An electrical motor may, for example, be provided portable power by a power storage module (e.g., batteries).

### SUMMARY

Apparatus and associated methods relate to a battery housing configured to selectively lock a battery to the housing when the battery is operated into electrical communication with the housing. In an illustrative example, the housing may have a first indexing member configured to slidingly engage a second indexing member of the battery such that a power terminal of the housing is brought into register with a power terminal of the battery. The housing may, for example, have a control module operably coupled to the housing power terminal and configured to operate the (mechanical) locking module between a lock mode and an unlock mode. The control module may, for example, be configured to operate the locking module into the lock mode when the power terminals are operated into electrical connection with each other. Various embodiments may advantageously automatically lock and/or unlock a battery module in response to predetermined operations.

Various embodiments may achieve one or more advantages. For example, some embodiments may advantageously readily maintain a substantially continuous supply of power for a vehicle. A battery module may, for example, advantageously be selectively locked into a power consumer and/or charging station. For example, the battery module may be advantageously prevented from loss (e.g., by accident during driving, from theft). For example, a battery module may advantageously be secured against unauthorized removal and/or accidental decoupling (e.g., due to vibrations during travel).

In various embodiments a receiving module may, for example, be configured to have an appearance of a traditional motor or portion thereof (e.g., a motor cylinder). Such embodiments may, for example, advantageously conceal a type of power used (e.g., electric vs liquid fuel) by a power consumer. For example, a vehicle may appear as a user-preferred engine driven vehicle, while being powered by electricity (e.g., achieving environmental, efficiency, and/or convenience benefits).

In various embodiments, an indexing element may, by way of example and not limitation, mechanically interact with a mating element in a receiver to advantageously locate, stabilize, and/or retain a battery pack in a desired configuration.

Various embodiments may advantageously provide one or more housings to encase a rechargeable battery. Some such embodiments may, for example, provide advantages of manufacturing large orders (e.g., of a battery and/or internal case) while still providing a customized appearance and/or functionality. Various embodiments may, for example, advantageously use relatively few and/or cost-effective components (e.g., an external case and/or internal case) for customized appearance and/or functionality while maintaining interoperability. In various embodiments an external case may advantageously conform to at least one “universal” interoperability standard (e.g., outer envelope dimensions and/or geometry). Accordingly, interoperability of a battery module between, for example, charging stations and/or power consumers may be advantageously maintained.

In some embodiments, power terminals of a battery may, for example, advantageously be shielded from unintended contact (e.g., reducing risk of shock and/or accidental discharge) by an outer battery housing (e.g., casing). In some embodiments, a battery housing (e.g., case) may advantageously provide a user with visual indicia of a charge level of a (rechargeable) battery.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary auto-locking interchangeable battery system (ALIBS) employed in an illustrative use-case scenario for providing power to a vehicle 105 via swappable battery modules 120 with a network including an exemplary public charging station 125 and residential charging station 130.

FIG. 2 depicts an exemplary assembly sequence of a swappable battery module 120.

FIG. 3 depicts a perspective view of the exemplary vehicle receiving module 115.

FIG. 4 depicts the exemplary public charging station 125 in an illustrative use-case scenario.

FIG. 5A and FIG. 5B depict an exemplary mobile device interface which may facilitate a user interacting with the exemplary public charging station 125.

FIG. 6 depicts an exemplary electrical circuit block diagram of an exemplary battery module 120, receiving module 115, and vehicle 105.

FIG. 7 depicts an exemplary electrical circuit block diagram of an exemplary battery module 120 and charging station 125.

FIG. 8 depicts an exemplary block diagram of an exemplary data transfer network in an illustrative rechargeable vehicle power use-case scenario.

FIG. 9 depicts a flow chart of an exemplary method for an exemplary user app interacting with the exemplary public charging station 125.

FIG. 10 depicts a flow chart of an exemplary method for the exemplary public charging station 125 receiving and/or dispensing exemplary battery modules 120.

Like reference symbols in the various drawings indicate like elements.

### DETAILED DESCRIPTION OF ILLUSTRATIVE EMBODIMENTS

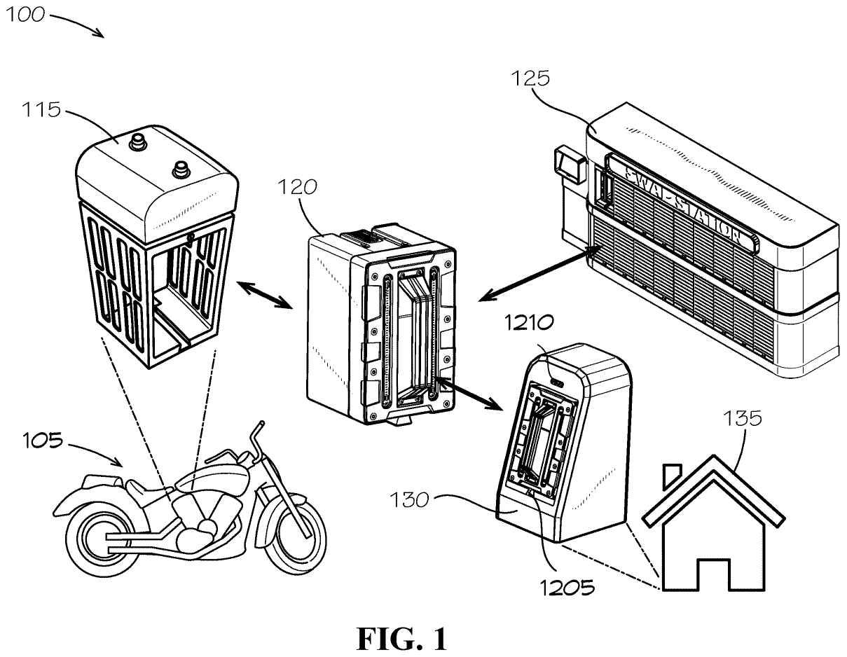

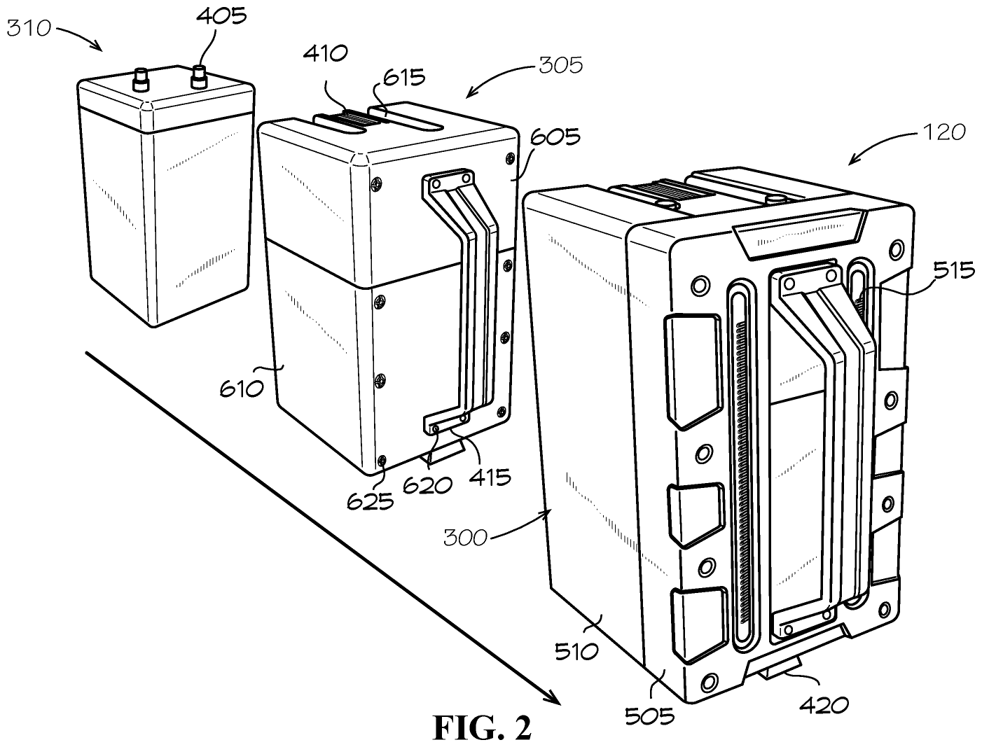

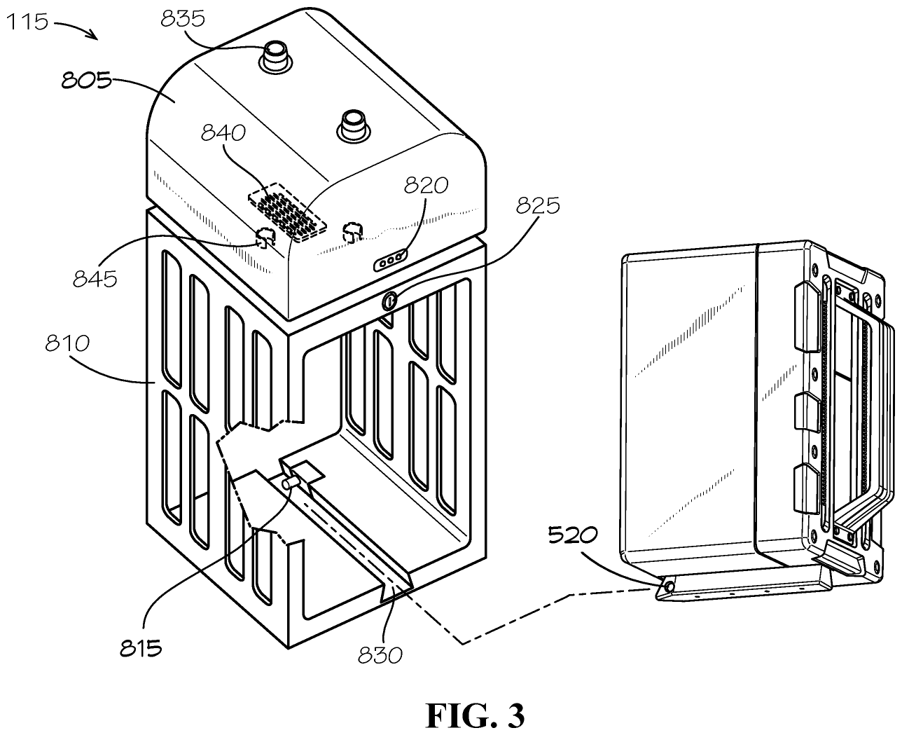

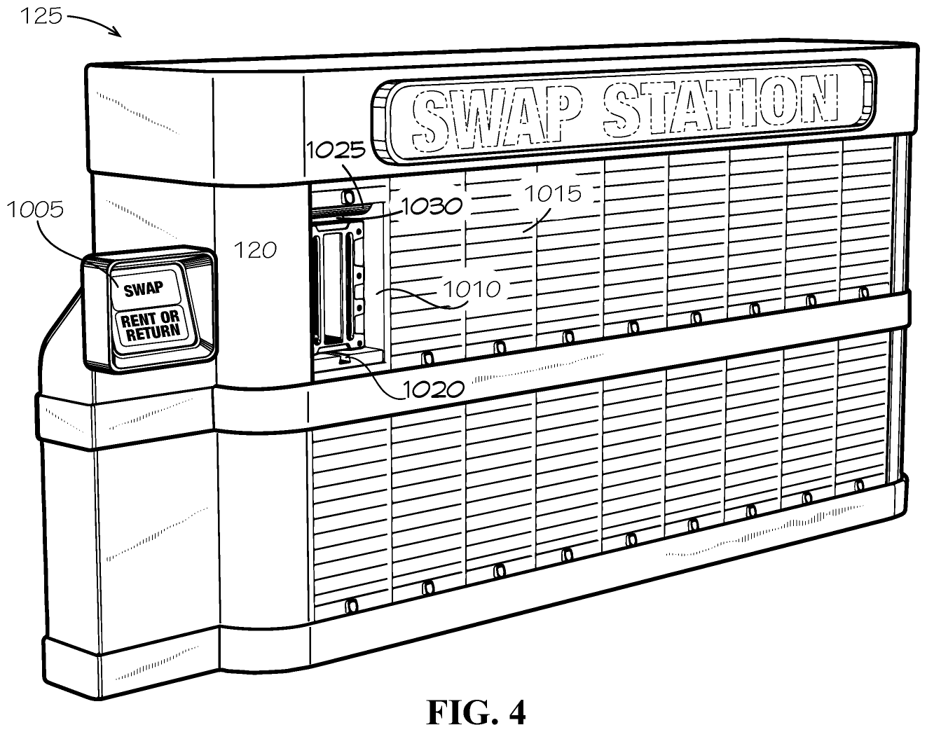

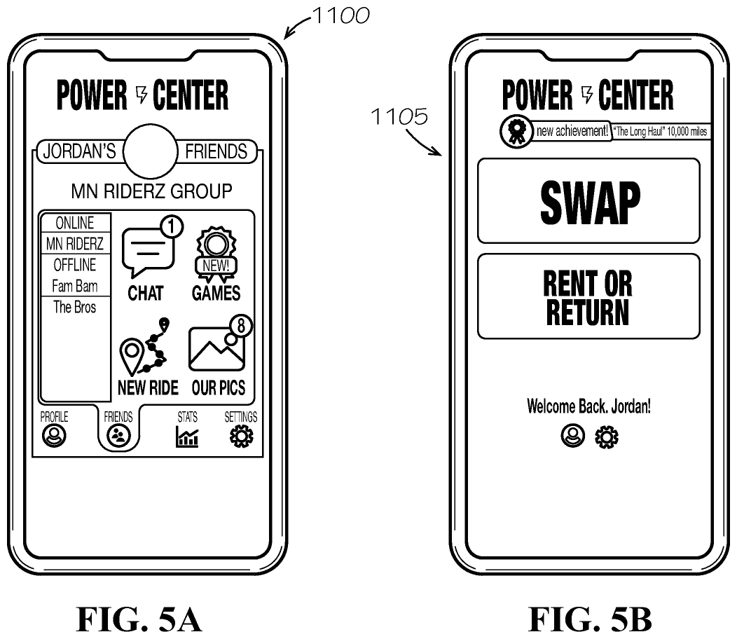

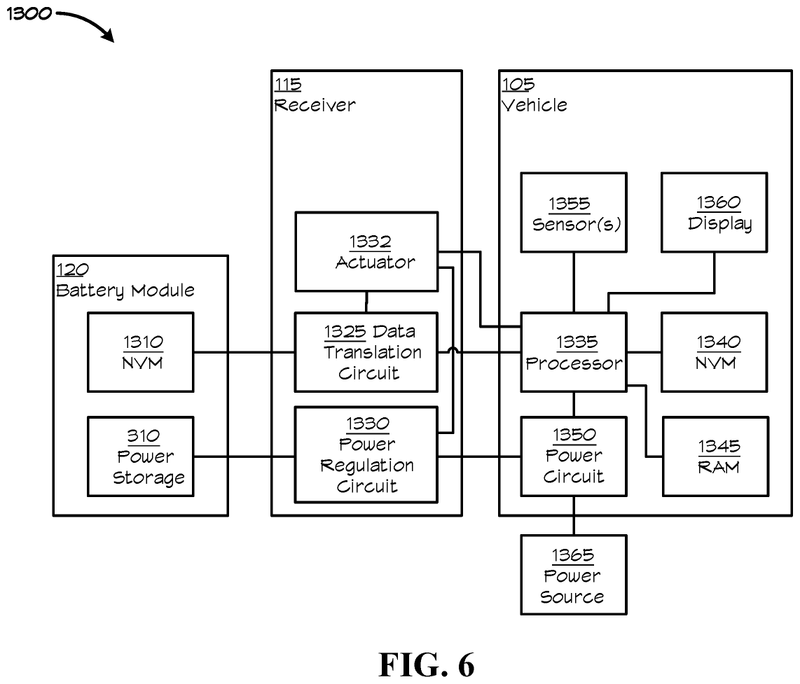

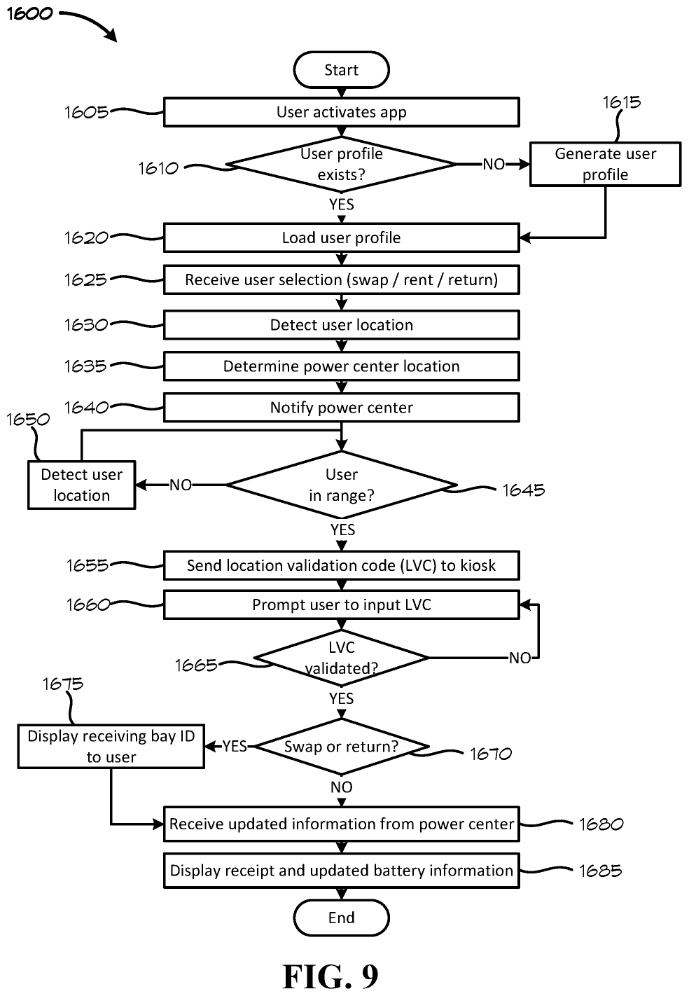

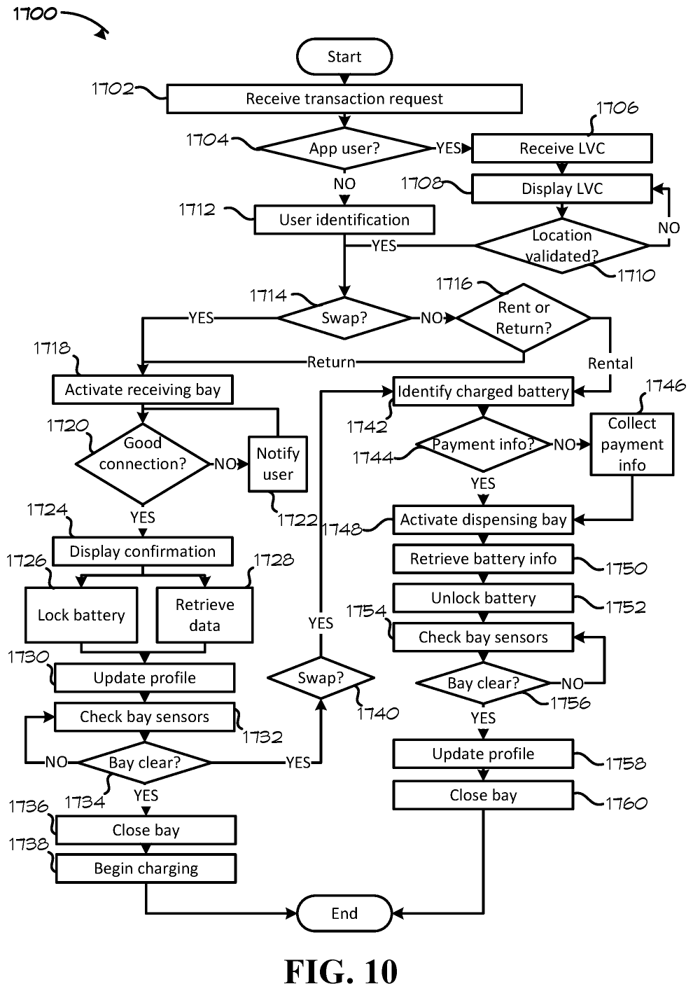

To aid understanding, this document is organized as follows. First, to help introduce discussion of various embodiments, an auto-locking interchangeable battery system (ALIBS) is introduced with reference to FIGS. 1-2. Second, that introduction leads into a description with reference to FIG. 3 of exemplary auto-locking module(s) of an ALIBS. Third, with reference to FIG. 4, exemplary charging stations for exemplary ALIBSs are described. Fourth, illustrative user interface(s) are described with reference to FIGS. 5A-5B in application to communication regarding ALIBSs. Fifth, with reference to FIGS. 6-8, the discussion turns to exemplary block-level circuit implementations of an exemplary ALIBS. Sixth, and with reference to FIGS. 9-10, this document describes exemplary methods useful for interacting with locking, unlocking, using, and/or charging in exemplary ALIBSs. Finally, the document discusses further embodiments, exemplary applications and aspects relating to ALIBSs.

FIG. 1 depicts an exemplary auto-locking interchangeable battery system (ALIBS) employed in an illustrative use-case scenario for providing power to a vehicle 105 via swappable battery modules 120 with a network including an exemplary public charging station 125 and residential charging station 130. In the depicted example 100, a vehicle (e.g., motorcycle) 105 is provided with a vehicle receiving module 115. The vehicle receiving module 115 is configured to releasably mechanically receive and retain and releasably electrically couple to the battery module 120. The vehicle 105 may be configured to receive power (e.g., to power an electric motor to drive the vehicle 105) from the battery module 120.

The battery module 120 is configured to be released and removed from the receiving module 115 (e.g., when a level of remaining electrical charge is below a user's desired level) and be inserted into a public charging station 125 (e.g., swapped for a charged battery module 120) or a residential charging station 130 (e.g., for recharging). The public charging station 125 may, for example, be located at a conveniently accessible public location (e.g., a dealer, a fuel station, a convenience store, a grocery store, an airport, a hotel). The residential charging station 130 may, for example, be conveniently located in the user's garage 135. Accordingly, the user may, for example, advantageously readily maintain a substantially continuous supply of power for the vehicle 105.

When the battery module 120 is operated into the receiving module 115 and/or a charging station (e.g., the exemplary public charging station 125, the residential charging station 130), a locking module may, for example, releasably couple the battery module 120 into the receiver. For example, when a user operates (e.g., slides) the battery module 120 into the receiving module 115 (e.g., of a vehicle), a locking module in the receiving module 115 may (automatically) operate into a lock mode such that the battery module 120 is (releasably) mechanically coupled to the receiving module 115. Accordingly, the battery module 120 may advantageously be prevented from loss (e.g., by accident during driving, from theft).

The locking module may, for example, be configured to operate into an unlock mode in response to a release signal. A release signal may, for example, be generated by an operator interface (e.g., button). A release signal may, for example, be generated in response to an input from a vehicle control module. In some embodiments, a release signal may, by way of example and not limitation, be generated in response to a user input on an app (e.g., running on a mobile computing device). The app may, for example, cause a signal to be transmitted to the receiving module 115 (e.g., directly, through a communication module of the vehicle).

In some embodiments, by way of example and not limitation, a release signal may include an authorization. For example, the release signal may include an association with the battery module 120 (e.g., a serial code and/or a user identification). The release signal may include an authorization code (e.g., a unique code, a dynamically generated code). The receiving module 115 may, for example, be configured to only unlock when the release signal includes an authorization (e.g., a predetermined code, a dynamically generated code meeting predetermined criterion(s)).

In the depicted example, the exemplary vehicle 105 is a motorcycle. The vehicle 105 is provided with the exemplary receiving module 115. In various embodiments the receiving module 115 may, for example, be configured to have an appearance of a traditional motor or portion thereof (e.g., a motor cylinder). Accordingly, the type of power used (e.g., electric vs liquid fuel) may be advantageously concealed. For example, a vehicle may appear as a user-preferred engine driven vehicle, while being powered by electricity (e.g., achieving environmental, efficiency, and/or convenience benefits).

In the depicted example, the receiving module 115 is configured to releasably receive and retain the battery module 120. In various embodiments at least two receiving modules 115 may be provided. In some embodiments, a single receiving module 115 may be configured to receive at least two battery modules 120. Accordingly, rechargeable battery modules 120 may advantageously be used to provide power to the vehicle 105.

In various embodiments a receiving module(s) 115 and battery module(s) 120 may be configured to provide power (e.g., electrical power) for various uses. For example, various embodiments may be configured to provide power for indoor and/or outdoor sports equipment (e.g., snowmobiles, scooters, go karts, UTVs, ATVs, dirt bikes), hand tools, medical equipment, vehicles (e.g., motorcycles, cars, trucks, aerial vehicles), other appropriate power consumers, or some combination thereof.

In the depicted example, the charging station 130 is provided with visual indicia 1210 (e.g., as discussed with reference to visual indicia 820 of FIG. 2). The charging station 130 is provided with an indexing channel 1205 (e.g., as discussed with reference to indexing channel 830 and/or indexing channel 1020 of FIGS. 3-4). In various embodiments the residential charging station may be provided with a power cable and associated plug configured to electrically couple with residential electrical receptacles (e.g., 110V, 220V). The residential charging station may, for example, be provided with a data transfer port an associated circuit(s) or may omit a data transfer port.

In various embodiments the residential charging station may be provided with circuit(s) to communicate with a network, a user's computing device (e.g., through the app discussed with reference to FIGS. 5A-5B), or some combination thereof. For example, a residential charging station may (e.g., in cooperation with an app on a user computing device(s)) alert a user when a battery module 120 is full; may alert a user when a battery module 120 needs replacement, repair, and/or maintenance; may provide a user remote access to determine a battery module state (e.g., presence, charge level); or some combination thereof.

In various embodiments the residential charging station 130 may be implemented in and/or configured for various non-residential environments. In various embodiments the charging station 130 may, by way of example and not limitation, be configured for implementation in a hospital, jobsite, commercial location, hotel, retail store, warehouse, other appropriate situs, or some combination thereof. In various embodiments the charging station 130 may be configured to hold more than one battery module 120, may be modularly constructed (e.g., to mechanically and/or electrically couple more than one charging station 130 unit together), or some combination thereof.

FIG. 2 depicts an exemplary assembly sequence of a swappable battery module 120. In the depicted example, a battery module 120 is provided with an external case 300. The external case is assembled around an internal case 305. The internal case 305 contains a battery 310. In various embodiments the battery 310 and the internal case 305 may be formed integrally with one another. In various embodiments the internal case 305 in the external case 300 may be formed integrally with one another. In various embodiments the entire assembly (e.g., of the battery module 120) may be formed integrally. Various integral embodiments may advantageously reduce components and/or assembly costs.

As depicted, the battery 310 is provided with positive and negative power terminals 405. The internal case 305 is assembled around the battery 310. The internal case 305 is provided with apertures to provide external access to the power terminals 405. The internal case 305 is provided with a data transfer port 410. The data transfer port 410 may, for example, include a storage module configured to store data (e.g., related to battery use, vehicle information, battery identification). The internal case 305 is further provided with a handle 415. The handle 415 may, for example, be configured to allow a user to lift the internal case 305 with battery pack.

The internal case 305 is further provided with an indexing element 420. As depicted, the indexing element 420 is a dovetail channel located on the bottom surface of the internal battery case 305. The indexing element 420 may, by way of example and not limitation, mechanically interact with a mating element in a receiving module 115 to advantageously locate, stabilized, and/or retain the battery module 120 in a desired configuration. In some embodiments, a channel (e.g., dovetail, T-channel, custom-shaped) may be located on a surface other than the bottom (e.g., side, top, multiple channels).

The external case 300 is assembled around the internal battery case 305. As depicted, the external case 300 is provided with apertures to allow external access to the power terminals 405, the data transfer port 410, to handle 415, and the indexing element 420. In various embodiments, the battery 310 may be a generic battery. The internal case 305 may, by way of example and not limitation, be configured to conform to at least one specific “universal” standard (e.g., for a specific industry, application, manufacturer, or some combination thereof). In various embodiments the internal case 305 may be assembled and provided by a battery manufacturer. The external case 300 may, by way of example and not limitation, be configured to conform to a specific manufacturer's specifications. for example, the external case 300 may be designed and or specified to conform to manufacturer, brand, and/or application specific criteria including, by way of example and not limitation, visual appearance, size, geometry, orientation, or some combination thereof. Accordingly, various embodiments may advantageously provide advantages of manufacturing large orders (e.g., of the battery 310 and/or internal case 305) while still providing a customized appearance and/or functionality using relatively few and/or cost-effective components (e.g., the external case 300 and/or internal case 305). In various embodiments the external case 300 may conform to at least one “universal” interoperability standard (e.g., outer envelope dimensions and/or geometry). Accordingly, interoperability of a battery module 120 between, for example, charging stations and/or power consumers may be advantageously maintained.

The battery module 120 is enclosed in the external case 300. As depicted, the external case 300 includes a front shell 505 and rear shell 510 which are assembled around the interior case 305. As depicted, the external case 300 is configured such that the power terminals 405 are sub flush with an outer surface of the external case 300. Accordingly, the power terminals 405 may advantageously be shielded from unintended contact (e.g., reducing risk of shock and/or accidental discharge).

The external case is provided with left and right battery charge level indicators 515. The indicators 515 may, for example, be provided with leads and contacts on an internal surface(s) of the external case 300 configured to electrically couple with circuit contacts on the internal battery case 305 and/or battery 310. For example, the indicators 515 may be connected to a circuit (in the battery 310, the internal case 305, and/or the external case 300) which interacts with the power terminals 405 and/or other battery power terminals. The data transfer port 410 may, for example, intermediate between the battery 310 and the power sensing circuit. For example, the indicators 515 may connect to the data transfer port 410 when the external case 300 is assembled over the internal case 305. Accordingly, various embodiments may advantageously provide a user with visual indicia of a charge level of the battery module 120.

The indexing element 420 is provided with a lock receiving feature 520. As depicted, the lock receiving feature 520 is an aperture through a web of the indexing element 420. The indexing element 420 may, for example, receive a locking element (e.g., a pin) to releasably couple the battery module 120 into a receiving module 115 and/or a charging station (e.g., 125, 130). Accordingly, the battery module 120 may advantageously be secured against unauthorized removal, accidental decoupling (e.g., due to vibrations during travel), or some combination thereof.

The internal case 305 is provided with an upper shell 605 and a lower shell 610. The upper shell 605 is provided with the data transfer port 410 and apertures 615 for the battery power terminals 405. The lower shell 610 is provided with the indexing element 420. As depicted, the upper shell 605 and the lower shell 610 are coupled together by the handle 415. In the depicted embodiment, the handle 415 is fastened to the internal case 305 by screws 620. The internal case 305, as depicted, is provided with features 625. In various embodiments the feature 625 may, for example, be securing elements, locating elements, fasteners, decorative elements, or some combination thereof.

In various embodiments the battery 310 may, for example, be a standard battery. The battery 310 may, by way of example and not limitation, be a lead acid battery, a glass mat battery, a lithium-ion battery, a fuel cell, other appropriate (electrical) energy storage composition, or some combination thereof.

FIG. 3 depicts a perspective view of the exemplary vehicle receiving module 115. In the depicted example the receiving module 115 is provided with an upper case 805 and lower case 810. The upper case 805 and the lower case 810 may, by way of example and not limitation, be unitarily formed or be assembled. In various embodiments the receiving module 115 may be formed to provide a specific ornamental appearance. In various embodiments, by way of example and not limitation, the receiving module 115 may be constructed to appear as an engine (e.g., at least some portion of an engine), an engine cylinder, a fuel tank, or some combination thereof. For example, the upper case 805 may be formed to appear as a cylinder head. The lower case 810 may, for example, be formed to appear as a cylinder body.

The receiving module 115 is provided with an indexing channel 830. The indexing channel 830 may be configured to slidingly receive the indexing element 420 of a battery module 120. The index in channel 830 is provided with a locking pin 815. The locking pin is configured to releasably be inserted into the lock receiving feature 520 of the indexing element 420.

The locking pin 815 may, for example, be operated by an (electrical) actuator (e.g., a linear or rotary electric motor). The locking pin 815 (e.g., via the electrical actuator) may be controlled by a circuit configured to retract the locking pin 815 at a user's command. The locking pin 815 may, by way of example and not limitation, retract in response to a user operating a key module 825 to release a battery module 120. The locking pin 815 may, for example, extend in response to a user locking (e.g., turning and/or removing a key in) operating the key module 825 to lock a battery module 120. In various embodiments the locking pin 815 may operate in response to a signal (e.g., wireless) from a mobile computing device (e.g., executing an app).

The receiving module 115 is provided with visual indicia 820. The visual indicia 820 may, for example, be configured to display to a user a state of a battery module 120 electrically coupled within the receiving module 115. In various embodiments the visual indicia 820 may display a status of a battery module 120 relating to, by way of example and not limitation, electrical connection, data connection, mechanical retention status (e.g., locked, unlocked), or some combination thereof.

In the depicted example, the upper case 805 is provided with power terminals 835. The power terminals 835 may, for example, be configured to couple (e.g., releasably) to a power transmission harness of a vehicle (e.g., power leads). The receiving module 115 is provided with a data port 840 and power receptacles 845. The data port 840 in the power of receptacles 845 may, for example, be configured to releasably electrically couple to the power terminals 405 and the data transfer port 410, respectively. The data port 840 may, for example, be spring-loaded or otherwise moveable. Accordingly, the data port 840 may be configured to slidingly and pressingly engage the data transfer port 410 as the corresponding battery module 120 is inserted into the receiving module 115. The power receptacles 845 may be configured, for example, to ‘snap’ over the power terminals 405 of the battery module 120. In various embodiments the power receptacles may be spring-loaded, may be configured to pressingly engage the power terminals 405, or some combination thereof.

The receiving module 115 may be provided with one or more circuits. The circuits may include, by way of example and not limitation, a data translation circuit, a power control circuit, a battery monitoring circuit, or some combination thereof. One or more of the circuits may, by way of example and not limitation, be disposed within the upper case 805. The data translation circuit may, for example, be configured to receive data from a power consumer (e.g., the vehicle 105), a charging station (e.g., 125, 130), the battery, or some combination thereof. The data translation circuit may, for example, translate data received from a power consumer to a predetermined format. The data translation circuit may, for example, translate data in a proprietary manufacturer format (e.g., of the power consumer) to a standard format of a power distribution network (e.g., a battery swap infrastructure). The data translation circuit may, for example, store translated data in a data store of the battery module 120 via the data transfer port 410. data received by the data translation circuit and stored in the battery module 120 may include, by way of example and not limitation, geographical location (e.g., GPS coordinates, locations, distance traveled), time(s) of use, duration(s) of use, power level(s), rate of power consumption, acceleration during travel, battery module identification (e.g., serial number), vehicle identification, or some combination thereof. In various embodiments the data translation circuit may receive data from the power control circuit or other circuit within the receiving module 115.

FIG. 4 depicts the exemplary public charging station 125 in an illustrative use-case scenario. In the depicted example the charging station 125 is provided with a kiosk 1005. As depicted, the kiosk includes a touch screen which may allow a user to choose to swap, rent, or return a battery module 120. In various embodiments the user may be able to enter profile and or payment information via the kiosk 1005. In various embodiments the charging station 125 (e.g., via a circuit(s) in the kiosk 1005) may be connected (wired or wirelessly) to a network (e.g., to the Internet). In various embodiments the charging station 125 may be configured to communicate with a user's mobile computing device (e.g., running an app).

The charging station 125 is provided with multiple bays to receive battery modules 120. A user may, for example, swap a battery module 120 by inserting a discharged battery module 120 into a receiving bay 1010 (depicted as open with a battery module 120 therein) and retrieving a charged battery module 120 from a dispensing bay 1015 (depicted as closed). In various embodiments a bay may, by way of example and not limitation, receive one or more battery modules 120. An individual bay may, for example, electrically and or mechanically releasably couple with corresponding features of a battery module 120. A bay may, for example, be provided with a door (e.g., manual, automatic), sensors (e.g., configured to sense user presence, battery position, battery connection, data connection, battery presence, door open/closed), or some combination thereof.

In the depicted example a bay is provided with an indexing channel 1020 configure to slidingly receive the indexing element 420 of the battery module 120. A locking pin (not shown) may be provided (e.g., such as is described with reference to FIG. 3). The locking pin may, for example, be provided with an actuator(s) and/or control circuit(s). A bay may be provided, for example, with a control region 1025. The control region 1025 may, for example, contain one or more electrical circuits (e.g., power circuit, data circuit). A coupling feature 1030 may depend from the control region 1025. The coupling feature 1030 may, for example, be spring loaded. The coupling feature 1030 may include features configured to releasably electrically and/or mechanically coupled with power terminals 405 in the data transfer port 410.

FIG. 5A and FIG. 5B depict an exemplary mobile device interface which may facilitate a user interacting with the exemplary public charging station 125. The mobile device interface may, for example, be generated by an app (e.g., containing a program of instructions) being executed on a user's mobile computing device, one or more remote servers (e.g., cloud servers), charging stations, vehicles (e.g., vehicle 105), or some combination thereof. As depicted, a first interface display 1100 provides social interaction capabilities (e.g., communicating with, tracking, and/or interacting with other users), games, pictures (e.g., posting and/or sharing), ride tracking (e.g., of travel using an associated vehicle), viewing statistics (e.g., distance traveled, locations visited, charging stations used, past transactions). A second interface display 1105 provides a user interface(s) for a user to initiate a swap, rental, or return of a battery module 120. The app may provide an interface (e.g., list, map) to facilitate a user searching for a nearby charging station. As depicted the first interface display 1100 and the second interface display 1105 provide advertisements which may be of interest to the user. The advertisements may, for example, be selected according to user information (e.g., transaction history, location history, preferences and/or settings, social interaction history).

FIG. 6 depicts an exemplary electrical circuit block diagram of an exemplary battery module 120, receiving module 115, and vehicle 105. In the depicted exemplary system 1300, the battery module 120 is provided with nonvolatile memory (NVM) 1310 (e.g., data store module) and a power storage module (e.g., battery 310, as depicted). The NVM 1310 may, for example, include the data transfer port 410. The receiving module 115 is provided with a data translation circuit 1325 and a power regulation circuit 1330. When the battery module 120 is coupled with the receiving module 115, the data translation circuit 1325 is in electrical communication with the NVM 1310 (e.g., via data transfer port 410 and data port 840) and the power regulation circuit 1330 is an electrical communication with the battery 310.

In the depicted example, the vehicle 105 is provided with at least one processor 1335. The processor 1335 is connected to NVM 1340 and to random access memory (RAM) module 1345. In the depicted example, the vehicle 105 may be provided with a power circuit 1350 (e.g., for power distribution, power regulation, power generation, power monitoring, or some combination thereof). The power circuit 1350 is an electric communication with the power regulation circuit 1330. The power circuit 1350 is further in communication with the processor 1335. For example, the process or 1335 make like data from and/or provide control signals to the power circuit 1350. In the depicted example, an optional power source 1365 is provided (e.g., “shore power” from a residence, charging station, or the power source). The power source 1365 may advantageously enable the battery module 120 to be charged without removal from the receiving module 115 and vehicle 105.

The processor 1335 is in electrical communication with the data translation circuit 1325. By way of example and not limitation, the processor 1335 may provide the data translation circuit 1325 with data related to the user, vehicle 105, battery usage, or some combination thereof, and/or may obtain data from the battery module 120 through the data translation circuit 1325.

In the depicted example, the receiving module 115 is further provided with at least one actuator module 1332. The actuator module 1332 may, for example, operate a locking mechanism (e.g., as discussed with reference to FIG. 3), a door mechanism (e.g., to close a door to retain and/or conceal the battery module 120 within the receiving module 115), or some combination thereof. The actuator module(s) 1332 are connected to the data translation circuit 1325 and the processor 1335. In various embodiments one or more actuator module 1332 may be connected to only one of the data translation circuit 1325 in the processor 1335.

In the depicted example, the vehicle 105 is provided with at least one sensor 1355 (e.g., configured to detect distance, acceleration, velocity, speed, location, user presence, battery presence, or some combination thereof) in electrical communication at least with the processor 1335. The vehicle 105 is further provided, in the depicted example, with at least one display 1360 (e.g., gauge(s), digital display) in electrical communication at least with the processor 1335. By way of example and not limitation, the display 1360 may be configured to display a charge level of the battery module 120. In various embodiments charge level display may be configured to appear like a fuel display. In various embodiments the display 1360 may be configured to display an estimated distance remaining on the current battery module(s) 120 based on charge level remaining and/or user history (e.g., acceleration profiles). various embodiments the display 1360 may be configured to display a distance to a next charging station. In some embodiments the display 1360 may be configured to alert a user if further use may take a user farther from a charging station than the battery module 120 charge level is estimated to last in use.

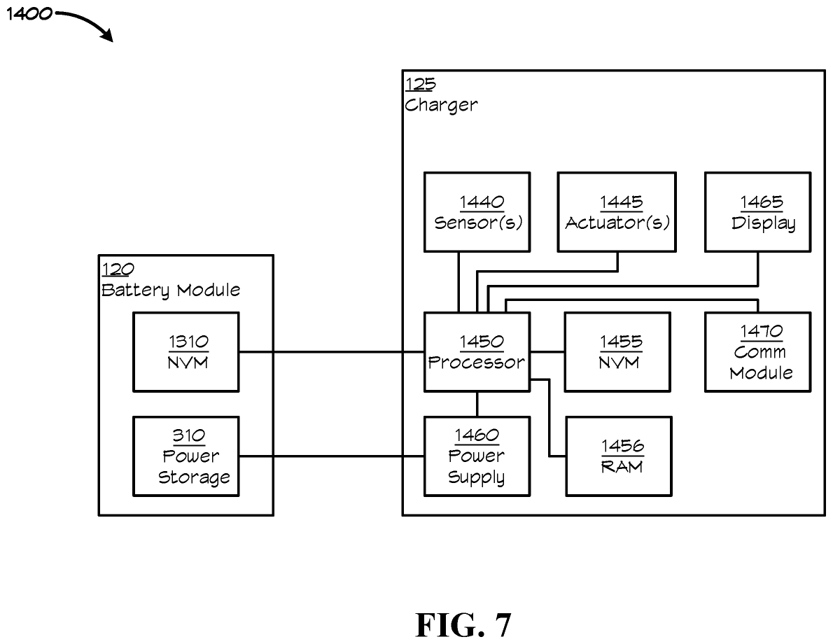

FIG. 7 depicts an exemplary electrical circuit block diagram of an exemplary battery module 120 and charging station 125. In the depicted exemplary system 1400, a public charging station 125 is provided with a processor 1450 connected to an NVM module 1455 and a RAM module 1456. The processor 1450 is in electrical communication with the NVM 1310 of the battery module 120. The processor 1450 is further in electrical communication with a power supply circuit (power supply 1460). The processor 1450 may, by way of example and not limitation, receive data from and/or provide control signals to the power supply 1460. The power supply 1460 is in electrical communication with battery 310 of the battery module 120.

In the depicted example, the charging station 125 is further provided with at least one actuator module 1445. The actuator module 1445 may, for example, operate a locking mechanism (e.g., as discussed with reference to FIG. 4), a door mechanism (e.g., bay doors), or some combination thereof. The actuator module(s) 1445 are connected to the processor 1450.

The charging station 125 is provided with at least one sensor 1440 (e.g., configured to detect user presence, battery presence, door position, charging status, battery condition, or some combination thereof) in electrical communication at least with the processor 1450. The charging station 125 is further provided, in the depicted example, with at least one display 1465 (e.g., kiosk discussed with reference to FIG. 4) in electrical communication at least with the processor 1450. By way of example and not limitation, the display 1465 may be configured to display transaction information, battery drop-off and/or retrieval information (e.g., receiving bay, dispensing bay), or some combination thereof. In various embodiments the display 1465 may be configured to receive information from a user and provide it to the processor 1450.

The charging station 125 is further provided with a communication module 1470. The communication module 1470 is in electrical communication with the processor 1450. The communication module may, by way of example and not limitation, provide wired and/or wireless communication between one or more remote devices (e.g., processors, data stores, mobile computing devices, servers), nearby user computing device, global navigational satellite system, or some combination thereof.

In various embodiments the charger may be configured as a residential charging station 130. In various such embodiments, by way of example and not limitation, the processor 1450 may not be in electrical communication with the NVM 1310, the communication module 1470 may be omitted, the display 1465 may be (partially) omitted (e.g., one or more visual indicia), one or more sensor(s) 1440 may be omitted, one or more actuator module 1445 may be omitted, or some combination thereof.

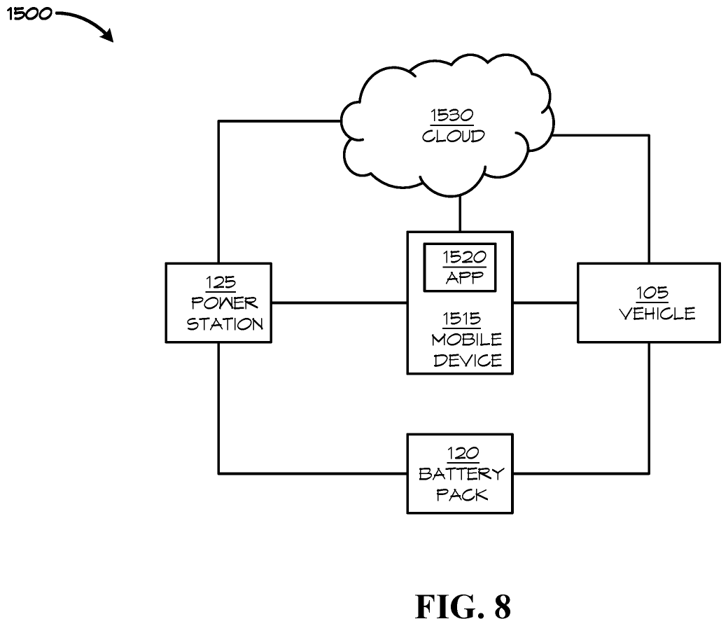

FIG. 8 depicts an exemplary block diagram of an exemplary data transfer network in an illustrative rechargeable vehicle power use-case scenario. In the depicted network 1500 battery module 120 selectively communicates with at least one of a vehicle 105 and a 125 (a power stations, labeled “charger”). The battery module 120 may, for example, communicate via the data transfer port 410. The battery module 120 may communicate with the vehicle 105 through a data port 840 of a corresponding receiving module 115 when in electrical communication therewith (e.g., when the battery module 120 is loaded into the vehicle 105). The battery module 120 may communicate with the charging station 125 (in various embodiments, the charging station 125 may, for example, be charging station 125 and/or residential charging station 130) through a data transfer port such as, for example, when the battery module 120 is in electrical communication with a bay of the charging station 125.

In the depicted example, a mobile device 1515 running an app 1520 is in communication with the charging station 125, the vehicle 105, at least one cloud server 1530, or some combination thereof. The charging station 125 is in communication with the cloud server 1530. The vehicle 105 is in communication with the cloud server 1530. Accordingly, the battery pack may, for example, be in communication with the user's mobile device and/or the mobile device 1515 via at least one of the charging station 125 and the vehicle 105. In various embodiments further devices (e.g., computing devices of manufacturers, third-parties, distributors) may be further connected to the cloud server 1530, the charging station 125, the vehicle 105, or some combination thereof. Accordingly, various embodiments may advantageously associated battery module specific information (e.g., identified by a (unique) battery module identifier such as a serial number), vehicle information, charging and/or transactional information, user information (e.g., via app 1520), or some combination thereof, via cloud server 1530.

FIG. 9 depicts a flow chart of an exemplary method for an exemplary user app interacting with the exemplary public charging station 125. The method 1600 begins when a user activates an app 1605, which checks 1610 if the user profile exists (e.g., when a user attempts to login). If the user profile does not exist 1610, then the user profile is generated 1615 (e.g., prompting a user for and receiving profile information). If the user profile does exist, then the user profile is loaded 1620.

The app receives 1625 a user selection (e.g., via second interface display 1105), detects 1630 the user location, and determines 1635 a power center (e.g., charging station 125) location. The method may, by way of example and not limitation, determine 1635 the power center location based on the user's current location, a distance to surrounding power center locations, current charge level in a battery, available charged battery modules and/or available receiving bays at power center locations, a user's preference, or some combination thereof. Once the power center location is determined 1630, the selected power center is notified 1640. The power center may, for example, reserve an appropriate dispensing bay(s) and/or receiving bay(s) (and associated battery module(s)) in response to receiving the notification in step 1640.

A distance between the user's current location and the selected power center location is compared 1645 to a predetermined range (e.g., threshold). The range may, for example, correspond to a user's physical presence at the power center location. If the user is not within the predetermined range, then the user's location is updated 1650 until the user enters predetermined range. Once the user is within 1645 the predetermined range, then a location validation code (LVC) is sent 1655 to a kiosk of the power center (in various embodiments a signal may be sent to the power center to generate an LVC). The app prompts 1660 the user to input the LVC and checks 1665 whether the LVC is received and valid. If the LDC is not received and or validated 1665, the app continues to prompt 1660 the user to input a valid LVC. Requiring the LVC may, for example, advantageously ensure the user is physically present before opening a dispensing bay and/or receiving bay, and/or completing the transaction. For example, various embodiments may advantageously prevent theft of a battery module 120 before a user arrives.

Once the LVC is validated 1665, if the user is swapping (e.g., exchanging a discharged battery module 120 for a charged battery module 120) or returning (e.g., depositing a battery module 120 without receiving a replacement) a battery module (decision point 1670), then the app displays 1675 an identifier of the receiving bay (e.g., code, number, visual map) to the user such that the user may locate an open bay to place the discharged battery module 120 into. Once the transaction is complete, the app receives 1680 updated information from the power center and displays 1685 receipt and updated battery information (e.g., current charge level, battery identification).

FIG. 10 depicts a flow chart of an exemplary method for the exemplary public charging station 125 receiving and/or dispensing exemplary battery modules 120. The depicted method 1700 begins by receiving a transaction request 1702. In various embodiments the transaction request may be received 1702 from, by way of example and not limitation, a mobile app, A kiosk, or some combination thereof. If the transaction request was received from an app 1704, then the location validation code (LVC) is received 1706 from the app and displayed 1708 (e.g., on the kiosk screen). The charging station checks 1710 whether the location has been validated via the app. If not, then the LVC is still displayed 1708. Once the location is validated 1710, then the method proceeds to step 1714.

If the transaction was not received from an app 1704, then user identification is collected 1712 (e.g., via the kiosk). If the user is swapping at least one battery module (step 1714), then a receiving bay (e.g., empty, non-reserved, operable) is selected and activated (e.g., a bay door is opened) 1718. The power center checks 1720 whether a good connection is established. If a good connection has not been established (e.g., battery inserted improperly or battery not inserted), then the user is notified 1722 (e.g., visual indicia, prompt on an app, prompt on the kiosk, audible feedback). Once a good connection has been established 1720, then confirmation is displayed 1724 (e.g., on an app, the kiosk, the receiving bay). The battery module is locked 1726 (e.g., by operating a locking module as described with reference to FIG. 3 and FIG. 6) and data is retrieved 1728 from the battery module (e.g., via the data transfer port 410 and data port 840 as described with relation to FIGS. 2-7). The user's profile is then updated 1730 (e.g., dissociation of the battery module's identification number with the user's account, charging and/or crediting the user's billing method, updating vehicle/usage information). The bay sensors (e.g., as discussed with reference to FIG. 7) are checked 1732 to determine 1734 if the user is clear of the bay (e.g., user's hands are safely out of the bay). If not, then the sensors continue to be checked 1732. Once the bay is clear 1734, then the bay is closed 1736 and the deposited battery module begins charging 1738. Once the bay is clear 1734, then the power center determines 1740 if a swap is in process (e.g., as determined at step 1714).

Returning to step 1714, in the swap is not processed then the power center determined 1716 if a rental (user obtaining a charged battery module 120 without returning a discharged battery module 120) or return (user returning a discharged battery module 120 without obtaining a charged battery module 120) has been initiated. If a return has been initiated, then the process proceeds to step 1718. If a rental has been initiated, or a discharged battery module 120 has been received and a swap has been determined 1740 to be in progress, then a dispensing bay with a charged battery is identified 1742.

Power center determines 1744 if payment information has been obtained for the user. If payment information has not been obtained (e.g., through the kiosk, app, associated user profile), then payment information is collected 1746. Once payment information has been determined 1744 to be collected, then the selected dispensing bay is activated 1748, battery module information retrieved 1750 (e.g., battery module identification, charge level), and the battery module unlocked 1752. The bay sensors are checked 1754 to determine 1756 if the bay is clear (e.g., battery removed and/or user hands clear of the dispensing bay). Once the bay is clear 1756, then the user's profile is updated 1758 (e.g., billing method charged, new battery information associated with the user, battery information updated) and the bay is closed 1760.

Although various embodiments have been described with reference to the figures, other embodiments are possible. For example, although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as 12V and/or 24V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a power system may include a first battery housing configured to selectively receive a second battery housing coupled to a rechargeable battery. The power system may include a first indexing member mechanically coupled to the first battery housing and configured to slidingly engage a second indexing member of the second battery housing such that a first power terminal of the first battery housing is brought into register with a second power terminal operably coupled to the rechargeable battery. The power system may include a control module operably coupled to the first power terminal and to a mechanical locking module and configured to operate the mechanical locking module between a lock mode and an unlock mode. In response to an electrical connection being established between the first power terminal and the second power terminal, then the control module may operate the mechanical locking module into the lock mode such that the second battery housing is releasably coupled to the first battery housing.

An external surface of the first battery housing may be shaped as at least a portion of an internal combustion engine. The internal combustion engine may be a V-block engine and the first battery housing may be disposed to form at least part of the V-block.

The mechanical locking module may include a locking member and an actuator configured to operate the locking member. The second indexing member may include a locking feature configured to receive the locking member in the lock mode. Operating the mechanical locking module into the lock mode may include actuating the actuator such that the locking member is operated into mechanical engagement with the locking feature.

The locking member may include a pin. The locking feature may include an aperture. The first indexing member may include a channel. The second indexing member may include a rail.

The control module may be configured to operate the mechanical locking module into the unlock mode in response to a predetermined signal associated with an authorization to unlock. The power system may include a first data port operably coupled to the control module. The power system may include an urging member configured to urge the first data port into contact with a second data port coupled to a data module mechanically coupled to at least one of the second battery housing and the rechargeable battery.

The control module may be configured such that, in response to the predetermined signal associated with the authorization to unlock, the control module performs operations including generate a data structure. The data structure may include metadata associated with consumption of power from the rechargeable battery during the lock mode. The control module may be configured to store the data structure on the data module.

The control module may be configured such that, in response to the predetermined signal associated with the authorization to unlock, the control module performs operations including generate a message including metadata associated with consumption of power from the rechargeable battery during the lock mode. The control module may be configured to transmit the message to a network connected server such that an account associated with a user of the rechargeable battery is updated with the metadata.

The control module may be configured to generate, in response to the mechanical locking module being operated into the lock mode, an electronic message comprising an identifier associated with the rechargeable battery. The control module may be configured to transmit the electronic message to a registration authority associated with at least one of the rechargeable battery and the first battery housing.

The first battery housing may be electrically coupled to a power consumer such that, in the lock mode, the power consumer receives power from the rechargeable battery. The power consumer may include a vehicle.

In an illustrative aspect, a power storage system may include a battery module. The power storage system may include a data module coupled to the battery module and including a first data port. The power storage system may include an alignment member mechanically coupled to the battery module and comprising a coupling member. In response to the alignment member slidingly engaging a receiving member of a battery receiving housing such that a data connection is established between the first data port and a second data port of the battery receiving housing, then an electrically powered locking member may be automatically activated to engage the coupling member such that the battery module is releasably coupled to the battery receiving housing.

The battery module may include a rechargeable battery. The battery module may include a battery housing substantially enclosing the rechargeable battery and mechanically coupled to the first data port. The battery housing may include an inner housing configured to substantially enclose the rechargeable battery. The battery housing may include an outer housing configured to substantially enclose the inner housing. The inner housing and the outer housing may be configured such that at least one battery power terminal is in electrical communication with a power terminal of the battery receiving housing when the battery module is releasably coupled to the battery receiving housing.

The alignment member may include a rail. The receiving member may include a channel configured to slidingly engage the rail such that the first data port is brought into register with the second data port.

The data module may be configured to receive and store a data structure including geographical metadata associated with consumption of power from the battery module when the battery module was in a locked mode. The data module may be configured to store an identification associated with the battery module.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A power system comprising:
a first battery housing configured to selectively receive a second battery housing coupled to a rechargeable battery;
a first indexing member mechanically coupled to the first battery housing and configured to slidingly engage a second indexing member of the second battery housing such that a first power terminal of the first battery housing is brought into register with a second power terminal operably coupled to the rechargeable battery; and,
a control module operably coupled to the first power terminal and to a mechanical locking module and configured to operate the mechanical locking module between a lock mode and an unlock mode,
wherein, in response to an electrical connection being established between the first power terminal and the second power terminal, then the control module operates the mechanical locking module into the lock mode such that the second battery housing is releasably coupled to the first battery housing.

2. The power system of claim 1, wherein an external surface of the first battery housing is shaped as at least a portion of an internal combustion engine.

3. The power system of claim 2, wherein the internal combustion engine is a V-block engine and the first battery housing is disposed to form at least part of the V-block.

4. The power system of claim 1, wherein:
the mechanical locking module comprises a locking member and an actuator configured to operate the locking member,
the second indexing member comprises a locking feature configured to receive the locking member in the lock mode, and
operating the mechanical locking module into the lock mode comprises actuating the actuator such that the locking member is operated into mechanical engagement with the locking feature.

5. The power system of claim 4, wherein the locking member comprises a pin and the locking feature comprises an aperture.

6. The power system of claim 1, wherein:
the first indexing member comprises a channel, and
the second indexing member comprises a rail.

7. The power system of claim 1, wherein the control module is further configured to operate the mechanical locking module into the unlock mode in response to a predetermined signal associated with an authorization to unlock.

8. The power system of claim 7, further comprising a first data port operably coupled to the control module.

9. The power system of claim 8, further comprising an urging member configured to urge the first data port into contact with a second data port coupled to a data module mechanically coupled to at least one of: the second battery housing, and the rechargeable battery.

10. The power system of claim 9, wherein the control module is configured such that, in response to the predetermined signal associated with the authorization to unlock, the control module performs operations comprising:
generate a data structure comprising metadata associated with consumption of power from the rechargeable battery during the lock mode; and,
store the data structure on the data module.

11. The power system of claim 9, wherein the control module is configured such that, in response to the predetermined signal associated with the authorization to unlock, the control module performs operations comprising:
generate a message comprising metadata associated with consumption of power from the rechargeable battery during the lock mode; and,
transmit the message to a network connected server such that an account associated with a user of the rechargeable battery is updated with the metadata.

12. The power system of claim 1, wherein the control module is configured to:
generate, in response to the mechanical locking module being operated into the lock mode, an electronic message comprising an identifier associated with the rechargeable battery; and,
to transmit the electronic message to a registration authority associated with at least one of the rechargeable battery and the first battery housing.

13. The power system of claim 1, wherein the first battery housing is electrically coupled to a power consumer such that, in the lock mode, the power consumer receives power from the rechargeable battery.

14. The power system of claim 13, wherein the power consumer comprises a vehicle.

15. A power storage system comprising:
a battery module;
a data module coupled to the battery module and comprising a first data port; and,
an alignment member mechanically coupled to the battery module and comprising a coupling member,
wherein, in response to the alignment member slidingly engaging a receiving member of a battery receiving housing such that a data connection is established between the first data port and a second data port of the battery receiving housing, then an electrically powered locking member is automatically activated to engage the coupling member such that the battery module is releasably coupled to the battery receiving housing.

16. The power storage system of claim 15, wherein the battery module comprises:
a rechargeable battery; and,
a battery housing substantially enclosing the rechargeable battery and mechanically coupled to the first data port.

17. The power storage system of claim 16, wherein the battery housing comprises:
an inner housing configured to substantially enclose the rechargeable battery; and,
an outer housing configured to substantially enclose the inner housing,
wherein the inner housing and the outer housing are configured such that at least one battery power terminal is in electrical communication with a power terminal of the battery receiving housing when the battery module is releasably coupled to the battery receiving housing.

18. The power storage system of claim 15, wherein:
the alignment member comprises a rail, and
the receiving member comprises a channel configured to slidingly engage the rail such that the first data port is brought into register with the second data port.

19. The power storage system of claim 15, wherein the data module is configured to receive and store a data structure comprising geographical metadata associated with consumption of power from the battery module when the battery module was in a locked mode.

20. The power storage system of claim 15, wherein the data module is configured to store an identification associated with the battery module.
